(19) United States
(12) Patent Application Publication
(10) Pub. No.: US 2012/0148322 A1
(43) Pub. Date: Jun. 14, 2012

(54) ANGLED ARRAY SENSOR METHOD AND SYSTEM FOR MEASURING MEDIA CURL

(75) Inventor: Joannes N. M. de Jong, Hopewell Junction, NY (US)

(73) Assignee: Xerox Corporation, Norwalk, CT (US)

(21) Appl. No.: 12/963,002

(22) Filed: Dec. 8, 2010

(51) Int. Cl. G03G 15/00; G01N 21/86

(52) U.S. Cl. 399/406; 250/559.19

(57) ABSTRACT

A method and system for accurately measuring a lead edge and a trail edge media curl utilizing an angled array sensor. One or more curled media sheets can be propelled in a process direction via a set of rollers/nips associated with a curler from a leading edge and/or trailing edge towards the angled array sensor. The angled array sensor having a rotation vector in the cross-process direction can be placed upstream or downstream of a media-propelling device and at an angle relative to the media sheet exiting the curler in order to calculate a function of sheet curl. The function of sheet curl can be obtained by measuring a point at which the propelled media sheet touches an array associated with the angled array sensor. Such a curl measurement approach enhances accuracy and robustness to environmental induced errors.

### TECHNICAL FIELD

Embodiments are generally related to rendering devices such as printers, multi-function devices, photocopy machines, fax machines, and the like. Embodiments are also related to curl detection sensors employed in the context of rendering devices. Embodiments are additionally related to the measurement of lead edge and trial edge media curl.

### BACKGROUND OF THE INVENTION

Media curl is frequently considered a root cause of paper jams and registration errors that can occur during rendering (e.g., printing) operations and can be exacerbated by high-density images and plural color rendering. Media curl can be induced by several factors such as, for example, relative humidity, paper weight, paper size, sides imaged or amount of image. Sheet curling, however, can occur even in the context of unprinted sheets of paper due to changes in ambient humidity or the moisture content of the paper. Sheet curl may also be imposed on purpose to improve sheet hold down performance in sheet transport system employing a vacuum or other hold down force.

Sheet curling can interfere with proper sheet feeding, causing sheet feeding jams, delays, or registration errors. If sheet curl is present in the output, it can interfere with proper stacking or other finishing operations. Furthermore, the amount of moisture in the sheet of paper can drastically change from the rendering process itself, to cause or exacerbate curl. The sheet curl problem can also occur in duplex printing, when the sheets are re-fed or re-circulated for rendering imaging material on their second sides, especially if that involves a second pass of the sheet through a thermal fuser and/or higher density images on one side than the other. The media curl must be measured and controlled so that reliable marking can be achieved and damage to an ink cartridge can be prevented.

Various media curl sensors and control systems are known in the electro photographic rendering arts. Such prior art systems typically employ a multiple-beam sensor such as, for example, a single cross beam sensor or a dual cross beam sensor for detecting the height/curl of the media sheet. Such beam sensors and their precise placement with respect to the nips, transfer belts, and media introduces further opportunity for variability of the sensor response characteristics. Additionally, such prior art curl measurement approaches are prone to edge errors due to air flow, machine vibrations, edge flip, etc., and hence the measurements are not accurate.

Based on the foregoing, it is believed that a need exists for an improved angled array sensor system and method for accurately measuring a lead edge and trail edge media curl, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved lead edge and trail edge curl sensor system and method.

It is another aspect of the disclosed embodiments to provide for an improved angled array sensor system and method for accurately measuring a lead edge and a trail edge media curl.

The aforementioned aspects and other objectives and advantages can now be achieved as described herein. A system and method for accurately measuring a lead edge and a trail edge media curl utilizing an angled array sensor is disclosed herein. One or more curled media sheets (e.g., paper, photo media, printing media, etc.) can be propelled in a process direction via a media-propelling device from a leading edge and/or trailing edge towards the angled array sensor (e.g., contact image sensor (CIS) module or CCD linear image sensor). The angled array sensor having a rotation vector in the cross-process direction can be placed upstream or downstream of the media-propelling device at an angle relative to the media sheet exiting the curler in order to calculate a function of sheet curl. The function of sheet curl can be obtained by measuring a point at which the propelled media sheet touches an array associated with the angled array sensor. Such a curl measurement approach enhances accuracy and robustness to environmental induced errors.

The curled media sheet enters the angled array sensor on a left side and/or a right side and proceeds through the media-propelling device in order to determine the lead edge curl and/or the trail edge curl function respectively. The system constrains the edge of the curled media sheet such that the array sensor is able to accurately measure the sheet media curl. The point of the media sheet with the array sensor can be the function of the sheet curl, array location, and angle. Each pixel with respect to the array sensor can be interrogated to detect the presence of the sheet edge. Optionally, a second array sensor can be added in order to measure a bi-directional curl with respect to the media sheet. Such a system and method permits multiple measurements of the media curl in order to reduce noise and improve accuracy. Additionally, the delivering method and device as discussed herein can constrain the media near the disclosed angled array sensor. The constraining or tangency allows the array touching point a more accurate measurement of media curl.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram depicting a curl measurement system equipped with an angled array sensor, in accordance with the disclosed embodiments;

FIG. 2 illustrates a graphical representation of the curl measurement system illustrating various curled media sheets touching the angled array sensor in different locations, in accordance with the disclosed embodiments;

FIG. 3 illustrates a graph representing media sheet curls as a function of sensor measurement, in accordance with the disclosed embodiments;

FIG. 4 illustrates a schematic diagram depicting a bi-directional curl measurement system associated with a pair of angled array sensor, in accordance with the disclosed embodiments; and

FIG. 5 illustrates a high level flow chart of operations illustrating logical operational steps of a method for measuring accurate media curl utilizing the angled array sensor, in accordance with the disclosed embodiments.

### DETAILED DESCRIPTION

The particular values and configurations discussed in these non-limiting examples can be varied and are cited merely to illustrate at least one embodiment and are not intended to limit the scope thereof. Note that in the configurations illustrated herein, media sheets (also referred to as simply “media”) shown entering (left to right) and exiting (right to left) are equivalent configurations. That is, media may enter left and exit right or enter right and exit left or enter and exit left or right, depending upon design configurations and the type of rendering device utilized.

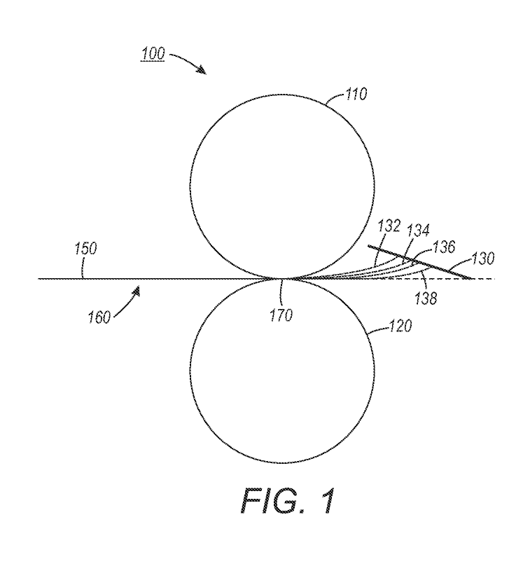

FIG. 1 illustrates a schematic diagram depicting a curl measurement system 100 equipped with an angled array sensor 130, in accordance with the disclosed embodiments. The curl measurement system 100 can be employed to measure media curls 132-138 with respect to one or more curled media sheets 150 in order to avoid paper jams and registration errors. The curl measurement system 100 can be implemented in the context of measuring a leading edge and/or a trail edge position of the media sheets 150 in a marking engine such as paper or transparencies in a xerographic rendering device. Note that as utilized herein, the term rendering device may refer to an apparatus or system such as a printer, fax machine, copy machine, etc., and/or a combination thereof.

The system 100 generally includes an angled array sensor 130 and transport nips 110 and 120. The function of the transport nips 110 and 120 with or without a potential upstream arrangement is to constrain the paper to be tangent at the transport nips. This improves the accuracy of curl measurement. It should be understood, however, that the transport nips 110 and 120 are only an example of how sheets can be delivered to the angled sensor. It can be appreciated that other arrangements and devices are possible. The transport nips 110 and 120 can be positioned on opposite sides of a media path 160 in order to receive the media sheet 150 and drive towards the angled array sensor 130. The term ‘media’ generally refers to sheets of paper and is typically stacked, and the transport nips 110 and 120 pull the top sheet from the stack and deliver it to the rendering device. For reference, the media sheet 150 may be described as having a leading edge, referring to the edge of the paper first to exit the rendering device. The edge of the paper last to leave the rendering device is called the trailing edge.

The curled media sheets 150 can be propelled via the transport nips 110 and 120 from the leading edge and/or the trailing edge towards the angled array sensor 130 in order to accurately measure the media curls 132-138. Note that the angled array sensor 130 can be such as, for example, a charge couple device or a contact image sensor made up of a series of linear pixels, depending upon design considerations. The contact image linear sensor (CIS) is a photoelectric device employed for scanning a flat pattern or a document into electronic formats in order to provide easy storage, display, edit or transfer capability. The sensor reproduces an image shown on a document on the sensor pixels.

The contact image sensor is usually provided as a module consisting of a light source, lens, and sensor. The module is called a Contact Image Sensor (CIS) module. The CCD linear image sensor is utilized for converting an image of light into an electrical signal. The CCD linear image sensor includes one or more of vertical charge-coupled devices (VCCD), horizontal charge-coupled devices (HCCD), and a sensing amp for sensing the image charge transferred in order to transfer the sensed image charge to an external peripheral circuit. It can be appreciated that other types of angled array sensor may be utilized in place of the suggested sensor.

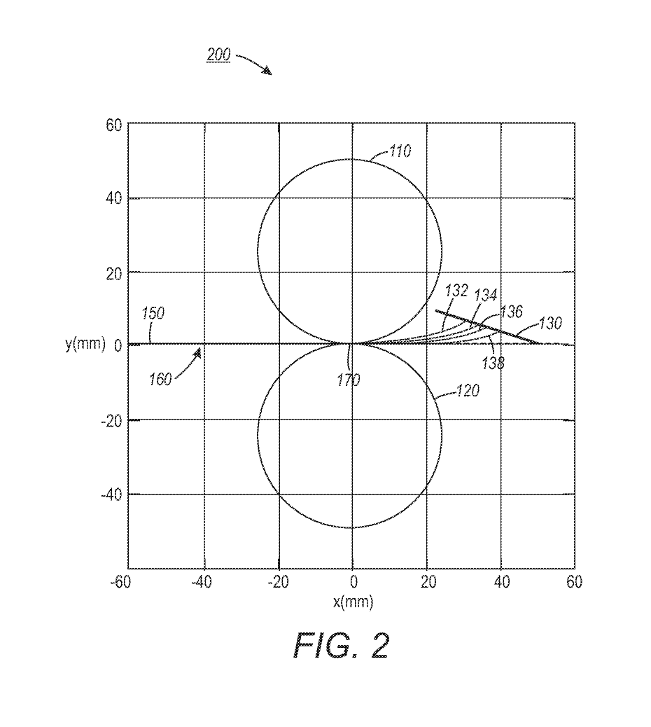

FIG. 2 illustrates a graphical representation of the curl measurement system 100 illustrating various curled media sheets 150 touching the angled array sensor 130 in different locations, in accordance with the disclosed embodiments. Note that in FIGS. 1-5, identical or similar parts are generally indicated by identical reference numerals. The curled media sheets 150 can be propelled in a process direction through the media-propelling device 170 associated with the transport nips 110 and 120 from the leading edge and/or trailing edge towards the angled array sensor 130. The angled array sensor 130 can be placed upstream or downstream of the media-propelling device 170 at an angle (e.g., 15°) relative to the media sheet 150 exiting the transport nips 110 and 120. The angled array sensor 130 possesses a rotation vector that is in the cross-process direction. A media sheet curl function can be obtained by measuring a point (e.g., a touching point) at which the propelled media sheets 150 touches an array associated with the angled array sensor 130.

The curled media sheet 150 enters the angled array sensor 130 on a left side and/or a right side and proceeds through the media-propelling device(s) of the transport nips 110 and 120 in order to determine the lead edge curl and/or the trail edge curl function respectively. The system 100 constrains the edge of the curled media sheet 150 such that the array sensor 130 is able to accurately measure the sheet media curl 132-138. Each pixel with respect to array sensor 130 can be interrogated to detect the presence of a sheet edge. The media sheet 150 is constraint to be held reasonably flat in the region x<0. The lead edge of the media sheet 150 can be permitted to freely assume its shape, i.e. for any part of the sheet that has a coordinate x>0. FIG. 2 depicts the media sheets 150 of various curl radii assuming the natural shape for x>0.

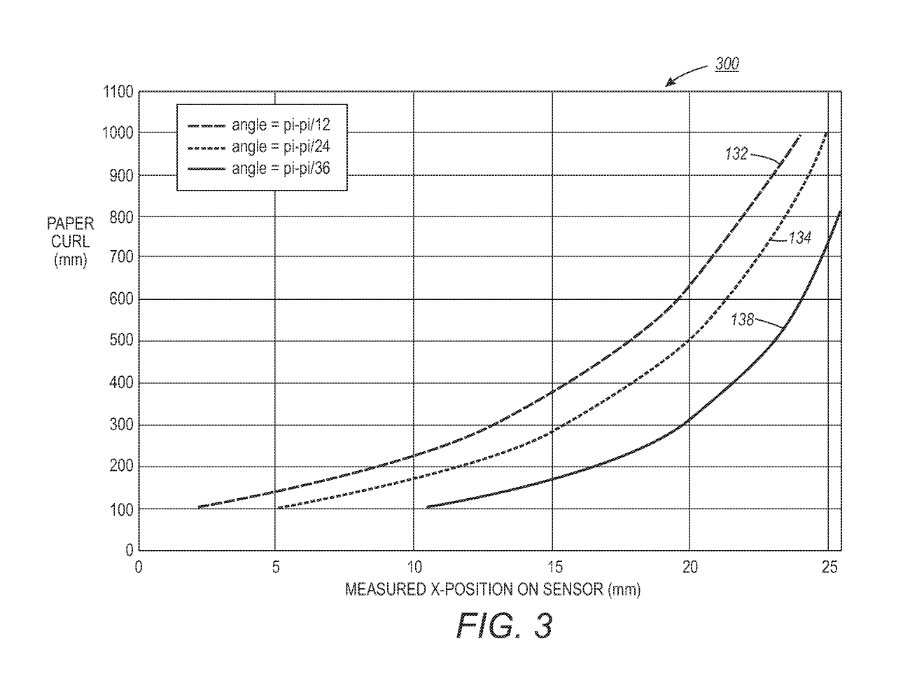

FIG. 3 illustrates a graph 300 representing the sheet media curls 132-138 as functions of sensor measurement, in accordance with the disclosed embodiments. The touching point of the media sheet 150 with the angled array sensor 130 can be the function of the sheet media curl 132-138, array location, and array angle. In the graph 300, the x-axis represents the measurement of the x-coordinate of the point of contact with the array sensor 130 and y-axis represents the measurement of media curl 132-138 with respect to the media sheets 150. The sensor 130 can be interrogated from left to right and at the first occurrence of a “sheet presence” denote the x-coordinate. The sheet curl can be calculated for a sheet curl radius R and a sensor face geometry described by a straight line as follows:

$$\begin{matrix}X = \frac{{Dd}_{y} \pm {sgn}^{*} ( {d}_{y} ) {d}_{x} \sqrt{{r}^{2} {d}_{r}^{2} - {D}^{2}}}{{d}_{r}^{2}} & ( 1 ) \\ Y = \frac{- {Dd}_{x} \pm {sgn}^{*} \vert {d}_{y} \vert \sqrt{{r}^{2} {d}_{r}^{2} - {D}^{2}}}{{d}_{r}^{2}} \\ wherein \text{:} & ( 2 ) \\ {d}_{x} = {x}_{2} - {x}_{1} & ( 3 ) \\ {d}_{y} = {y}_{2} - {y}_{1} & ( 4 ) \\ {d}_{r} = \sqrt{{d}_{x}^{2} + {d}_{y}^{2}} & ( 5 ) \\ D = \vert \begin{matrix}{x}_{1} & {x}_{2} \\ {y}_{1} & {y}_{2}\end{matrix} \vert = {x}_{1} {y}_{2} - {x}_{2} {y}_{1} & ( 6 ) \\ {sig}^{*} ( x ) ≡ \{ \begin{matrix}- 1 & for x < 0 \\ 1 & otherwise .\end{matrix} & ( 7 )\end{matrix}$$

The points (x₁, y₁) and (x₂, y₂) represent two end points of the rotation vector of the sensor array 130 with respect to a coordinate plane and dᵣ represent the length of the sensor array rotation vector. The equation (1) and equation (2) can determine the exact touching point of the media 150 with the angled array sensor 130. The curl measurement system, 100 is capable of measuring the curl 132-138 of the media 150 with high sensitivity, i.e., with smaller sensor angles. Such a system and method permits multiple measurements of the media sheet curl in order to reduce noise and improve accuracy.

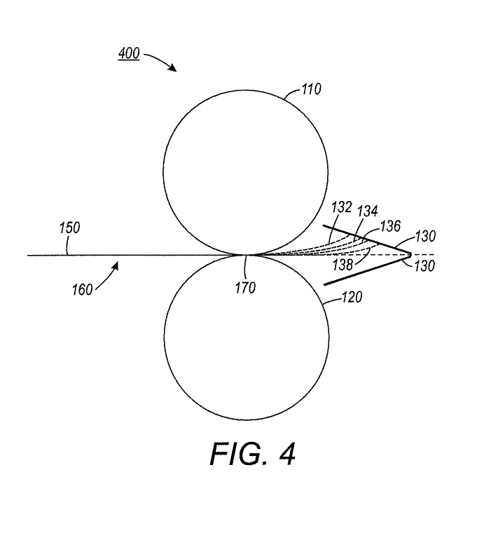

FIG. 4 illustrates a schematic diagram depicting a bi-directional curl measurement system 400 associated with a pair of angled array sensor 130, in accordance with the disclosed embodiments. The bi-directional curl measurement system 400 can be configured with the angled array sensor 130 on each side of the media path 160 in order to measure both positive curl and negative curl associated with the media sheet 150. Note that the bi-directional measurement system 400 may not be necessary while measuring the uni-directional curl of the media sheet 150.

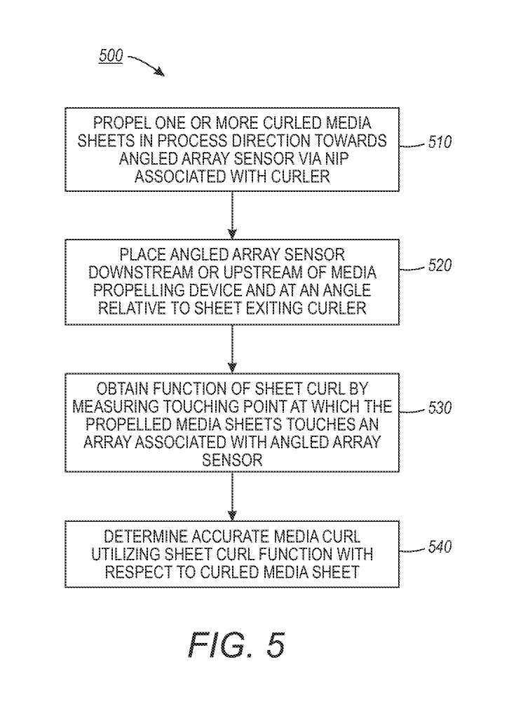

FIG. 5 illustrates a high level flow chart of operations illustrating logical operational steps of a method 500 for measuring accurate media sheet curl 132-138 utilizing the angled array sensor 130, in accordance with the disclosed embodiments. As indicated at block 510, one or more curled media sheets 150 can be propelled in a process direction towards an angled array sensor via a nip associated with the curler. Next, as depicted at block 520, the angled array sensor can be placed downstream or upstream of the media propelling device and at an angle relative to the media sheet 150 exiting the curler.

The angled array sensor 130 is ideally suited for curl measurement as each pixel can be interrogated in order to detect the presence of the media sheet 150 edge. The function of the media sheet curl 132-138 can be obtained by measuring the touching point at which the propelled media sheets 150 touches an array associated with the angled array sensor 130, as indicated at block 530. Thereafter, the accurate sheet curl can be determined utilizing the sheet curl function, as depicted at block 540. Such an approach provides an accurate sheet curl 132-138 measurement eliminating the errors induced by edge movement due to air flow, machine vibrations, edge flip, etc.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims. For example, the delivering device can be upstream or downstream from the angled array sensor described herein. Additionally, the delivering method and/or device or system can be configured to constrain the media near the angle sensor. The constraining or tangency makes the array touching point a more accurate measurement of media curl.

What is claimed is:

1. A method for measuring media sheet curl, said method comprising:
propelling at least one curled media sheet in a process direction via a media-propelling device towards an angled array sensor from an edge wherein said angled array sensor possess a rotation vector in a cross-process direction; and
measuring a point at which said at least one curled media sheet touches an array associated with said angled array sensor in order to obtain a function of a sheet curl, thereby enhancing accuracy and robustness with respect to an environmental induced error.

2. The method of claim 1 further comprising placing said angled array sensor upstream or downstream of said media-propelling device and at an angle relative to said media sheet exiting said curler in order to calculate said function of sheet curl.

3. The method of claim 1 further comprising constraining an edge of said curled media sheet in order to accurately measure said sheet media curl via said angled array sensor.

4. The method of claim 1 further comprising measuring said sheet curl as said at least one curled media sheet enters said angled array sensor from a leading edge.

5. The method of claim 1 further comprising measuring said sheet curl as said at least one curled media sheet enters said angled array sensor from a trailing edge.

6. The method of claim 1 further comprising interrogating each pixel on said array with respect to said array sensor to detect a presence of said sheet edge.

7. The method of claim 1 further comprising adding a second angled array sensor in order to measure a bi-directional media curl.

8. The method of claim 1 wherein said angled array sensor comprises a contact image sensor module.

9. The method of claim 1 wherein said angled array sensor comprises a charge coupled device linear image sensor.

10. A system for measuring media sheet curl, said system comprising:
an angled array sensor having a rotation vector in a cross-process direction;
a media propelling device for propelling at least one curled media sheet in a process direction towards said angled array sensor from an edge; and
a measurement device for measuring a point at which said at least one curled media sheet touches an array associated with said angled array sensor in order to obtain a function of a sheet curl, thereby enhancing accuracy and robustness with respect to an environmental induced error.

11. The system of claim 10 wherein said angled array sensor is located upstream or downstream of said media-propelling device and at an angle relative to said media sheet exiting said curler in order to calculate said function of sheet curl.

12. The system of claim 10 wherein an edge of said curled media sheet is constrainable in order to accurately measure said sheet media curl via said angled array sensor.

13. The system of claim 10 wherein said sheet curl is measurable as said at least one curled media sheet enters said angled array sensor from a leading edge.

14. The system of claim 10 wherein said sheet curl is measureable as said at least one curled media sheet enters said angled array sensor from a trailing edge.

15. The system of claim 10 wherein each pixel on said array is interrogated with respect to said array sensor to detect a presence of said sheet edge.

16. The system of claim 10 further comprising a second angled array sensor that assists in measuring a bi-directional media curl.

17. The system of claim 10 wherein said angled array sensor comprises a contact image sensor module.

18. The system of claim 10 wherein said angled array sensor comprises a charge coupled device linear image sensor.

19. A system for measuring media sheet curl, said system comprising:
an angled array sensor having a rotation vector in a cross-process direction;
a media propelling device for propelling at least one curled media sheet in a process direction towards said angled array sensor from an edge, wherein said angled array sensor is located upstream or downstream of said media-propelling device and at an angle relative to said media sheet exiting said curler in order to calculate said function of sheet curl; and
a measurement device for measuring a point at which said at least one curled media sheet touches an array associated with said angled array sensor in order to obtain a function of a sheet curl, thereby enhancing accuracy and robustness with respect to an environmental induced error.

20. The system of claim 19 wherein:
an edge of said curled media sheet is constrainable in order to accurately measure said sheet media curl via said angled array sensor;
said sheet curl is measurable as said at least one curled media sheet enters said angled array sensor from a leading edge; and
said sheet curl is measureable as said at least one curled media sheet enters said angled array sensor from a trailing edge.
